(19) United States
(12) Patent Application Publication
(10) Pub. No.: US 2026/0359270 A1
(43) Pub. Date: Nov. 12, 2026

(54) ASYNCHRONOUS TRANSACTION PROCESSING FOR STORAGE CONTAINERS

(71) Applicant: Nutanix, Inc., San Jose, CA (US)

(72) Inventors: Arth Patel, Bangalore (IN); Dheer Moghe, Bangalore (IN); Gautham L, Coimbatore Tamilnadu (IN); Monil Devang Shah, Milpitas, CA (US); Ramya Bolla, San Jose, CA (US)

(21) Appl. No.: 19/271,596

(22) Filed: Jul. 16, 2025

(30) Foreign Application Priority Data
May 9, 2025 (IN) 202541045125

(51) Int. Cl. G06F 16/18

(52) U.S. Cl. CPC G06F 16/1865

(57) ABSTRACT

A technique alleviates backlog of namespace operations recorded in a journal employed by a file system in a multi-site disaster recovery environment. Processing of the namespace operations by a primary file system at a primary site of the environment may be adaptively configured to dynamically transition (switch) from asynchronous mode to synchronous mode (and thereafter back to asynchronous mode) based on feedback received from a secondary file system on a secondary site. The feedback may be embodied as flow control information indicative of a rate at which the secondary file system processes the namespace operations, wherein the processing rate is computed based on a queue size of namespace operations pending (e.g., backlogged) in the journal.

### CROSS-REFERENCE TO RELATED APPLICATION

The present application claims the benefit of India Provisional Patent Application Serial No. 202541045125, which was filed on May 9, 2025, by Arth Patel, et al. for ASYNCHRONOUS TRANSACTION PROCESSING FOR STORAGE CONTAINERS, which is hereby incorporated by reference.

### BACKGROUND

### Technical Field

The present disclosure relates to data replication and, more specifically, to replication of file system metadata from a primary site to a secondary site of a data replication environment.

### Background Information

A storage system is a computer that provides a storage service relating to the organization of information on writable persistent storage devices. The storage system may include an operating system that implements a file system which may be logically organized as blocks, files or objects. File systems organized as files are usually implemented as a hierarchical structure of directories and logical entities, e.g., files, on the storage devices and contain information (metadata) that describes the files. Steady-state synchronous replication of file systems includes replication of data and metadata from a primary file system at a primary cluster of nodes (primary site) to a secondary file system at a secondary site. Typically, file system operations that update (change) the metadata for multiple files and/or directories are recorded (logged) to ensure that the operations are consistent across these multiple files and/or directories. The metadata updates, e.g., namespace operations, are operations that impact (change) the file system directory structure, such as creation and deletion of directories and files, renames, etc.

During a namespace heavy workload, i.e., when a burst of namespace changing operations enters the primary file system, the secondary file system may fall behind (backlog) processing and updating the namespace operations, such that the metadata updates may not be performed as fast as expected, i.e., the metadata update capability of the secondary file system is overwhelmed and operations are logged for later processing. Thus, the secondary file system may encounter a slow-down or lag (delay) in processing the namespace metadata operations so that namespace metadata updates to be performed may be queued up (backlogged) at the secondary file system. The lag (delay) of the secondary file system processing is dependent on how fast the primary file system forwards the namespace operations. Hence, there is a need for a technique to manage processing of namespace metadata updates by controlling how such operations are provided at the secondary file system.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of nodes interconnected as a cluster in a virtualized environment;

FIG. 2 is a block diagram of a virtualization architecture executing on a node to implement the virtualization environment;

FIG. 3 is a diagram illustrating an exemplary input/output (I/O) path of the virtualization architecture;

FIG. 4 is a diagram illustrating an exemplary steady-state replication of file systems in a multi-site data replication environment, such as disaster recovery (DR); and

FIG. 5 is a diagram illustrating exemplary feedback used in replication of file systems in the multi-site DR environment.

### OVERVIEW

The embodiments described herein are directed to a technique configured to alleviate backlog of unprocessed (i.e., unapplied) file system operations recorded in a journal employed by a file system in a multi-site data replication environment, such as a disaster recovery (DR) environment. Data replication in the DR environment involves synchronous replication of file system data and metadata from a primary file system at a primary site to a secondary file system at a secondary site, wherein the primary and secondary file systems are typically synchronized at the granularity of a storage container configured to store the data and metadata. The file system operations that are recorded (logged) in the journal include operations that update (change) the metadata of multiple files in the file system, such as namespace operations. Illustratively, the journal is a write-ahead log (WAL) that is configured to ensure atomicity and consistency of the file system operations by logging (recording) the operations before updating the metadata to persistent storage. The file system operations logged on the WAL include metadata updates, e.g., namespace operations, that impact (change) the file system directory structure, such as creation and deletion of directories and files, renames, etc.

In an embodiment, the namespace operations, e.g., included in namespace requests issued by a client, are logged (as one or more records) in a primary WAL of the primary file system at the primary site and synchronously replicated to the secondary file system at the secondary site. The replicated WAL record is logged at the secondary WAL and acknowledged (as persistently stored) back to the primary site, which then acknowledges completion of the namespace operation to the client. The replicated WAL records are then synchronously performed (processed), e.g., immediately in-line with the replication (i.e., operation-by-operation as they are completed), at the secondary site in accordance with a synchronous processing mode. However, the namespace operations logged at the primary WAL may be batched and updated together to be asynchronously processed (i.e., multiple asynchronous operations may be combined into one single batch update and applied asynchronously or concurrently, but still applied in correct order, in accordance with an asynchronous processing mode) by the primary file system at the primary site. Such asynchronous processing may help increase processing speed and reduce the total updates needed, e.g., if the same file is being updated again and again, by only applying the final update once so that intermediate updates are reduced. In this manner, the primary site may process namespace operations either in synchronous mode or asynchronous mode so that corresponding processing of replicated operations at the secondary site do not backup, i.e., a capacity of the secondary site to process such namespace operations is not overwhelmed. Moreover, the capacity of the WAL is not overwhelmed and a drift in namespace consistency is limited between the primary and secondary sites which impacts disaster recovery time.

In an embodiment, processing of the namespace operations by the primary file system at the primary site may be adaptively configured to dynamically transition (switch) from asynchronous mode to synchronous mode (and thereafter back to asynchronous mode) based on feedback received from the secondary file system on the secondary site. According to the technique, the feedback may be embodied as flow control information indicative of a rate at which the secondary file system processes the namespace operations, wherein the processing rate is computed based on a queue size of namespace operations pending (e.g., backlogged) in the secondary WAL. Illustratively, the feedback may include a count of the pending namespace operations in the secondary WAL that have yet to be processed per storage container. The secondary site may communicate (send) the flow control information (feedback) to the primary site as part of (“piggy-backed” onto) the persistent storage acknowledgement returned by the secondary site to the primary site.

Operationally, if the namespace operations are queued up (backlogged) above a predetermined threshold, then the secondary site sends the feedback to the primary site indicating that the primary file system needs to effectively slow down its namespace operation replication to the secondary site. The feedback, in turn, triggers a slowdown of processing of these namespace operations at the primary site as replication to the secondary site coincides with processing at the primary site to maintain namespace consistency between the sites. In response, the primary file system dynamically switches from asynchronous mode to synchronous mode for processing the namespace operations, i.e., logging WAL records and executing metadata updates synchronously and in-line (i.e., operation-by-operation as completed) with the acknowledgement response to the client indicating completion of the namespace operation.

Illustratively, synchronous mode reduces the rate of namespace operation replication by requiring synchronous acknowledgement of each recorded namespace operation at the primary site with the result that sufficient processing capacity is made available at the secondary site to process existing WAL records ostensibly to prevent overwhelming the capacity of the WAL. Notably, a secondary site may be configured with less resource capability than a primary site due to cost or misconfiguration which results in less ability of the secondary site to process namespace operations than the primary site. As such, switching to synchronous namespace operation processing mode at the primary site, in turn, slows down (i.e., reduces the frequency of) the acknowledgement responses to the client and, hence, reduces the frequency of newer namespace operation requests issued by the client, resulting in a lower rate of file system update operations replicated to the secondary site for processing. The reduced frequency of newer operation request issuances allows the secondary site time to catch up with the primary site so that the WAL at the secondary site is not overwhelmed and any drift in namespace consistency between the sites is reduced. When the backlog of namespace operation updates on the secondary site falls below the predetermined threshold, the primary site dynamically switches back to asynchronous mode for processing the namespace operations.

### DESCRIPTION

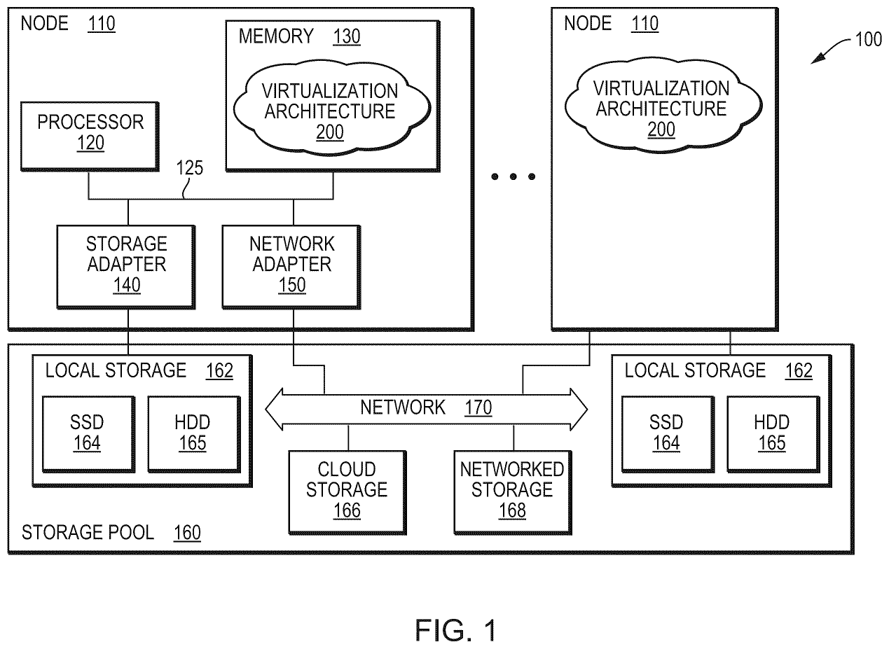

FIG. 1 is a block diagram of a plurality of nodes 110 interconnected as a cluster 100 and configured to provide compute and storage services for information, i.e., data and metadata, stored on storage devices of a virtualization environment. Each node 110 is illustratively embodied as a physical computer having hardware resources, such as one or more processors 120, main memory 130, one or more storage adapters 140, and one or more network adapters 150 coupled by an interconnect, such as a system bus 125. The storage adapter 140 may be configured to access information stored on storage devices, such as solid-state drives (SSDs) 164 and magnetic hard disk drives (HDDs) 165, which are organized as local storage 162 and virtualized within multiple tiers of storage as a unified storage pool 160, referred to as scale-out converged storage (SOCS) accessible cluster wide. To that end, the storage adapter 140 may include input/output (I/O) interface circuitry that couples to the storage devices over an I/O interconnect arrangement, such as a conventional peripheral component interconnect (PCI) or serial ATA (SATA) topology.

The network adapter 150 connects the node 110 to other nodes 110 of the cluster 100 over a network, which is illustratively an Ethernet local area network (LAN) 170. The network adapter 150 may thus be embodied as a network interface card having the mechanical, electrical and signaling circuitry needed to connect the node 110 to the LAN. In an embodiment, one or more intermediate stations (e.g., a network switch, router, or virtual private network gateway) may interconnect the LAN with network segments organized as a wide area network (WAN) to enable communication between the nodes of cluster 100 and remote nodes of a remote cluster over the LAN and WAN (hereinafter “network”) as described further herein. The multiple tiers of SOCS include storage that is accessible through the network, such as cloud storage 166 and/or networked storage 168, as well as the local storage 162 within or directly attached to the node 110 and managed as part of the storage pool 160 of storage items, such as files and/or logical units (LUNs). The cloud and/or networked storage may be embodied as network attached storage (NAS) or storage area network (SAN) and include combinations of storage devices (e.g., SSDs and/or HDDs) from the storage pool 160. Communication over the network may be affected by exchanging discrete frames or packets of data according to protocols, such as the Transmission Control Protocol/Internet Protocol (TCP/IP) and User Datagram Protocol (UDP), as well as protocols for authentication, such as the OpenID Connect (OIDC) protocol, while other protocols for secure transmission, such as the HyperText Transfer Protocol Secure (HTTPS) may also be advantageously employed.

The main memory 130 includes a plurality of memory locations addressable by the processor 120 and/or adapters for storing software code (e.g., processes and/or services) and data structures associated with the embodiments described herein. The processor and adapters may, in turn, include processing elements and/or circuitry configured to execute the software code, such as virtualization software of virtualization architecture 200, and manipulate the data structures. As described herein, the virtualization architecture 200 enables each node 110 to execute (run) one or more virtual machines that write data to the unified storage pool 160 as if they were writing to a SAN. The virtualization environment provided by the virtualization architecture 200 relocates data closer to the virtual machines consuming the data by storing the data locally on the local storage 162 of the cluster 100 (if desired), resulting in higher performance at a lower cost. The virtualization environment can horizontally scale from a few nodes 110 to a large number of nodes, enabling organizations to scale their infrastructure as their needs grow.

It will be apparent to those skilled in the art that other types of processing elements and memory, including various computer-readable media, may be used to store and execute program instructions pertaining to the embodiments described herein. Also, while the embodiments herein are described in terms of software code, processes, and computer (e.g., application) programs stored in memory, alternative embodiments also include the code, processes, and programs being embodied as logic, components, and/or modules consisting of hardware, software, firmware, or combinations thereof.

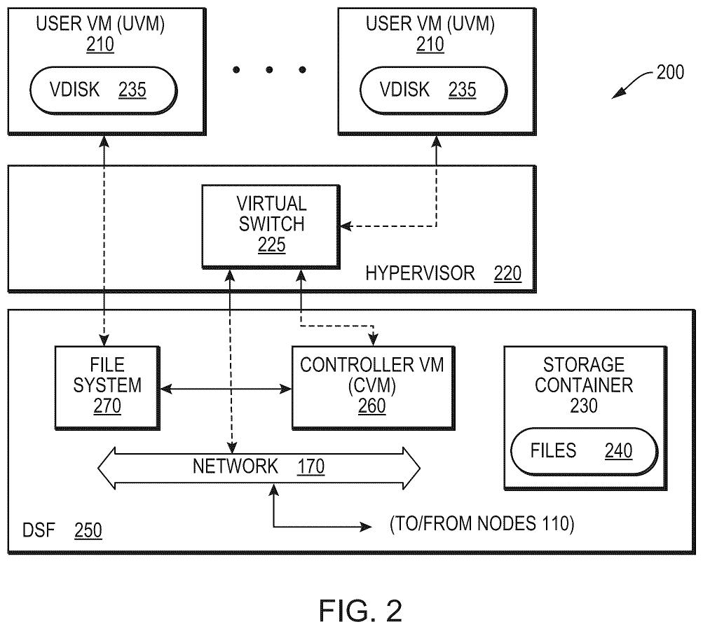

FIG. 2 is a block diagram of a virtualization architecture 200 executing on a node to implement the virtualization environment. Each node 110 of the cluster 100 includes software components that interact and cooperate with the hardware resources to implement virtualization. The software components include a hypervisor 220, which is a virtualization platform configured to mask low-level hardware operations from one or more guest operating systems executing in one or more user virtual machines (UVMs) 210 that run client software. The hypervisor 220 allocates the hardware resources dynamically and transparently to manage interactions between the underlying hardware and the UVMs 210. In an embodiment, the hypervisor 220 is illustratively the Nutanix Acropolis Hypervisor (AHV), although other types of hypervisors, such as the Xen hypervisor, Microsoft's Hyper-V, RedHat's KVM, and/or VMware's ESXi, may be used in accordance with the embodiments described herein.

Another software component running on each node 110 is a special virtual machine, called a controller virtual machine (CVM) 260, which functions as a virtual controller for SOCS. The CVMs 260 on the nodes 110 of the cluster 100 interact and cooperate to form a distributed data processing system that manages all storage resources in the cluster. Illustratively, the CVMs and storage resources that they manage provide an abstraction of a distributed storage fabric (DSF) 250 that scales with the number of nodes 110 in the cluster 100 to provide cluster-wide distributed storage of data and access to the storage resources with data redundancy across the cluster. That is, unlike traditional NAS/SAN solutions that are limited to a small number of fixed controllers, the virtualization architecture 200 continues to scale as more nodes are added with data distributed across the storage resources of the cluster. As such, the cluster operates as a hyper-convergence architecture wherein the nodes provide both storage and computational resources available cluster wide.

A file system 270 is a software component that provides file services to the UVMs 210 including storing, retrieving, and processing (executing) data access operations requested by the UVMs 210 and directed to data stored on the DSF 250. The stored data may be represented as a set of storage items, such as files organized in a hierarchical structure of folders (also known as directories), which can contain files and other folders, as well as shares, which can also contain files and folders. An inode is a data structure that is associated with a file (and/or directory) and contains information (metadata) that describes the file, such as a type (e.g., regular or directory) of file, a size of the file, time stamps (e.g., access and/or modification) for the file, and permissions (e.g., to access the file). Illustratively, the file system 270 may communicate with storage resources provided by CVM 260 to store and retrieve files, folders, or other storage items stored on storage pool 160. The file system 270 may also store and retrieve block-level data, including block-level representations of the storage items, on the storage pool 160.

The client software (e.g., applications) running in the UVMs 210 may access the DSF 250 using filesystem protocols, such as the network file system (NFS) protocol, the server message block (SMB) protocol, the common internet file system (CIFS) protocol, and the internet small computer system interface (iSCSI) protocol. Operations on these filesystem protocols are interposed at the hypervisor 220 and forwarded to the file system 270, which cooperates with the CVM 260 to perform the operations on data stored on local storage 162 of the storage pool 160. The CVM 260 may export one or more iSCSI, CIFS, or NFS targets organized from the storage items in the storage pool 160 of DSF 250 to appear as disks to the UVMs 210. These targets are virtualized, e.g., by software running on the CVMs, and exported as virtual disks (vdisks) 235 to the UVMs 210. In some embodiments, the vdisk is exposed via iSCSI, SMB, CIFS or NFS and is mounted as a virtual disk on the UVM 210. User data (including the guest operating systems) in the UVMs 210 reside on the vdisks 235 and operations on the vdisks are mapped to physical storage devices (SSDs and/or HDDs) located in DSF 250 of the cluster 100.

In an embodiment, the virtual switch 225 may be employed to enable I/O accesses from a UVM 210 to a storage device via a CVM 260 on the same or different node 110. The UVM 210 may issue the I/O accesses as a SCSI protocol request to the storage device. Illustratively, the hypervisor 220 intercepts the SCSI request and converts it to an iSCSI, CIFS, or NFS request as part of its hardware emulation layer. As previously noted, a virtual SCSI disk attached to the UVM 210 may be embodied as either an iSCSI LUN or a file served by an NFS or CIFS server. An iSCSI initiator, SMB/CIFS or NFS client software may be employed to convert the SCSI-formatted UVM request into an appropriate iSCSI, CIFS or NFS formatted request that can be processed by the CVM 300. As used herein, the terms iSCSI, CIFS and NFS may be interchangeably used to refer to an IP-based storage protocol used to communicate between the hypervisor 220 and the CVM 300. This approach obviates the need to individually reconfigure the software executing in the UVMs to directly operate with the IP-based storage protocol as the IP-based storage is transparently provided to the UVM.

For example, the IP-based storage protocol request may designate an IP address of a CVM 260 from which the UVM 210 desires I/O services. The IP-based storage protocol request may be sent from the UVM 210 to the virtual switch 225 within the hypervisor 220 configured to forward the request to a destination for servicing the request. If the request is intended to be processed by the CVM 260 within the same node as the UVM 210, then the IP-based storage protocol request is internally forwarded within the node to the CVM. The CVM 260 is configured and structured to properly interpret and process that request. Notably the IP-based storage protocol request packets may remain in the node 110 when the communication—the request and the response—begins and ends within the hypervisor 220. In other embodiments, the IP-based storage protocol request may be routed by the virtual switch 225 to a CVM 260 on another node of the same or different cluster for processing. Specifically, the IP-based storage protocol request may be forwarded by the virtual switch 225 to an intermediate station (not shown) for transmission over the network (e.g., WAN) to the other node. The virtual switch 225 within the hypervisor 220 on the other node then forwards the request to the CVM 260 on that node for further processing.

Operationally, a UVM 210 may send a data access request (e.g., a read or write operation) to the file system 270 via the hypervisor 220, and the file system 270 may perform the operation specified by the request. The file system 270 may present a virtualized file system to the UVM 210 as a namespace of mappable shared drives or mountable network filesystems of files and directories. The namespace of the virtualized filesystem may be implemented using storage devices of the storage pool 160, onto which the shared drives or network filesystems, files, and folders, or portions thereof, may be distributed as determined by the file system 270. The storage pool 160 may be logically segmented into one or more storage containers 230 for storing storage items, such as files 240 (and/or directories). The file system 270 may present the storage capacity of the storage devices as an efficient, highly available, and scalable namespace (directory structure) in which the UVMs 210 may create and access shares, files, and/or folders. As an example, a network share may be presented to a UVM 210 as one or more discrete vdisks 235, but each vdisk may correspond to any part of one or more virtual or physical disks (storage devices) within storage pool 160. The file system 270 may access the storage pool 160 (and storage containers 230) via the CVM 260. The CVM 260 may cooperate with the file system 270 to perform requests to the storage pool 160 using local storage 162 within the same node 110, by connecting via the network 170 to cloud storage 166 or networked storage 168, or by connecting via the network 170 to local storage 162 within another node 110 of the cluster (e.g., by connecting to another CVM 260).

As used herein, a storage container 230 is a logical construct that provides an encapsulation of storage space (e.g., for a client) for storing files 240 (and/or directories) in the file system 270, e.g., one or more storage containers 230 may contain one or more subsets of the files 240 in the file system. Different storage containers 230 may have different properties such as, e.g., type of encryption, compression, replication factor, etc. Each storage container 230 thus has its own configuration with respect to how its files 240 are treated or handled. Each storage container 230 also has a unique (independent) namespace, e.g., a mount point (root directory) and file system directory structure (file hierarchy) that differs among other storage containers. The storage container namespace may span any number of directories and files within the container. The technique described herein is directed to namespaces of storage containers (as opposed to namespaces of file systems).

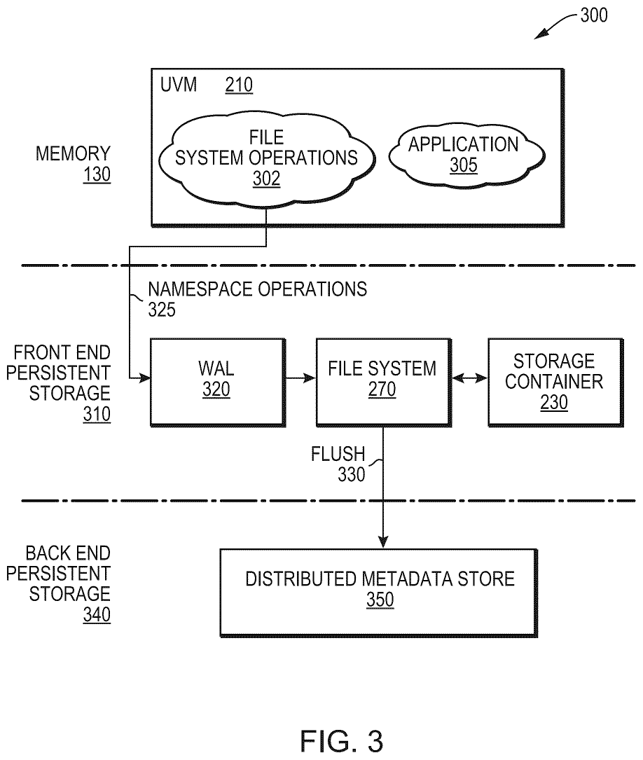

FIG. 3 is a diagram illustrating an exemplary input/output (I/O) path 300 of the virtualization architecture. An application 305 running in UVM 210 (e.g., client) of a node 110 issues I/O requests and file system update operations 302, that are forwarded to file system 270. In an embodiment, the file system is a journaling file system that employs a journal to ensure that the file system operations are atomic and consistent. Illustratively, the journal is a write ahead log (WAL 320) configured to ensure atomicity and consistency of updates (changes) to metadata (that typically occur in the WAL prior to updating a distributed metadata store) by recording (logging) certain file system operations (e.g., namespace operations 325) on the WAL 320 (e.g., located on front-end persistent storage 310 of SSDs of node 110) before the file system applies the changes to the metadata and flushes 330 (committed) the metadata updates to the distributed metadata store 350 (e.g., located on back-end persistent storage 340 of SSDs and/or HDDs coupled to node 110). The namespace operations 325 recorded on the WAL 320 are operations that change the file system directory structure, e.g., creation and/or deletion of directories and/or files. The directories and/or files may be stored in one or more storage containers 230.

Data replication generally involves copying (replicating) information (e.g., data and metadata) among one or more nodes 110 of clusters 100 embodied as, e.g., datacenters to enable continued operation of data processing operations in a multi-site data replication environment, such as backup, content distribution and disaster recovery. The multi-site data replication environment includes two or more datacenters, i.e., sites, which are typically geographically separated by relatively large distances and connected over a communication network, such as a WAN. For example, data at a local datacenter (primary site) may be replicated over the network to a remote datacenter (secondary site) located at a geographically separated distance to ensure continuity of data processing operations in the event of a failure of the nodes at the primary site.

Synchronous replication may be used to replicate the information between the sites such that each update to the information at the primary site is copied to the secondary site. For instance, every update (e.g., write operation) issued by a UVM 210 to information designated for replication (i.e., replication information) is continuously replicated from the primary site to the secondary site before the write operation is acknowledged to the UVM. Thus, if the primary site fails, the secondary site has an exact (i.e., mirror copy) of the replication information at all times. Synchronous replication generally does not require the use of snapshots of the information; however, to establish a multi-site data replication environment or to facilitate recovery from, e.g., network outages in such an environment, a snapshot may be employed to establish a point-in-time reference from which the sites can (re)synchronize the replication information.

In the absence of continuous synchronous replication between the sites, the current state of the replication information at the secondary site always “lags behind” (is not synchronized with) that of the primary site resulting in possible information loss in the event of a failure of the primary site. If a specified amount of time lag in synchronization is tolerable (e.g., 60 mins), then asynchronous (incremental) replication may be selected between the sites, for example, a point-in-time image replication from the primary site to the secondary site is not more than 60 minutes behind. Incremental replication generally involves at least two point-in-time images or snapshots of the information to be replicated, e.g., a base snapshot that is used as a reference and a current snapshot that is used to identify incremental changes to the information since the base snapshot. To facilitate efficient incremental replication in a multi-site data protection environment, a base snapshot is required at each site. Note that the information to be replicated may include an entire state of a file system including file system data and metadata.

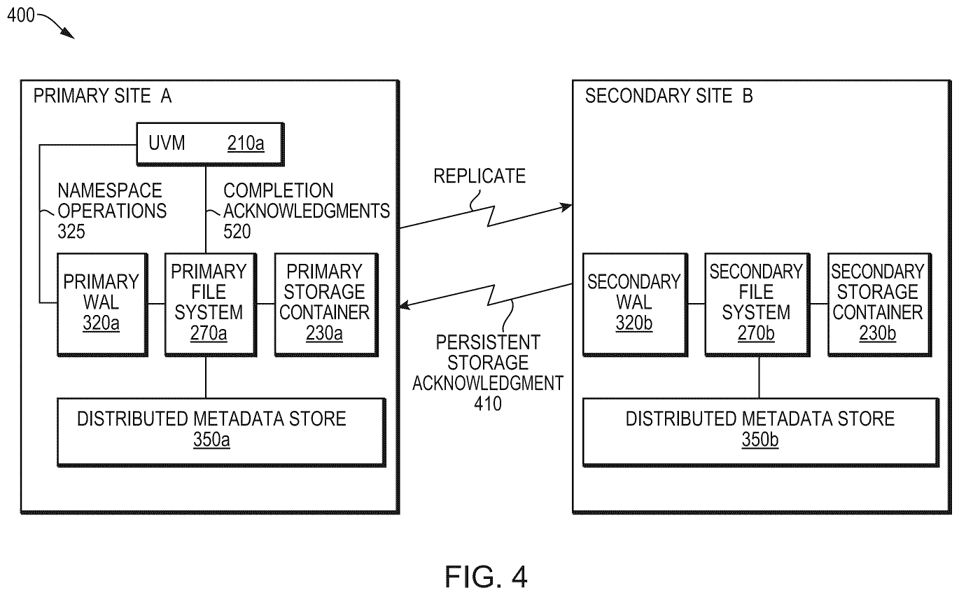

FIG. 4 is a diagram illustrating an exemplary steady-state replication of file systems in a multi-site data replication environment, such as disaster recovery (DR). In an embodiment, the steady-state replication 400 involves synchronous replication (and data consistency) of file system data and metadata from a primary file system 270a at the primary site A to a secondary file system 270b at secondary site B. Each of the file systems employs a WAL (primary WAL 320a and secondary WAL 320b) to record (log) metadata update operations, e.g., namespace operations 325, which operations impact the file system directory structure, such as creation and deletion of directories and files, of a storage container 230 (primary storage container 230a and secondary storage container 230b). The primary and secondary file systems are illustratively synchronized at the granularity of the storage containers 230a,b. The multi-site DR environment may be further embodied as a stretch cluster DR environment wherein content of primary storage container 230a on the primary site A is identical (synchronously replicated or protected) to secondary storage container 230b on the secondary site B. In such an environment, the name and file hierarchy of the storage containers 230a,b are the same at each site (i.e., the sites also maintain namespace consistency between each other). Accordingly, in response to a failure that impacts failover data (e.g., a UVM 210a) and its associated storage container 230a on the primary site A, the failover data (e.g., UVM 210b) can easily boot up on the remote site's storage container 230b since the containers are identical, i.e., synchronously protected.

In an embodiment, namespace operations 325 issued by a client (e.g., UVM 210a) are logged on the primary WAL 320a associated with primary storage container 230a on the primary site A. If the operations are directed to content (e.g., one or more files 240) of the primary storage container 230a that is synchronously protected (e.g., protected in a continuous synchronous replication mode) to the secondary site B, the operations are replicated to the secondary site B and logged in the secondary WAL 320b associated with the secondary storage container 230b, which is identical (and corresponding) to the primary storage container 230a. Each namespace operation translates to (manifests as) a WAL record logged in the primary WAL 320a and is immediately replicated to the secondary site B. The replicated WAL record is logged at the secondary WAL 320b and acknowledged (as persistently stored) back to the primary site A, which then acknowledges completion of the namespace operation to the client. Processing of the namespace operations at either site is performed as the WAL 320a,b is processed at each respective site. Notably, secondary sites are usually configured with less capability than a primary sites due to cost which results in less ability of the secondary site to process namespace operations than the primary site.

After sending the persistent storage acknowledgement 410 to the primary site A, the secondary site B has a persisted state of the namespace operation (e.g., change) to be performed (e.g., persisted in the secondary WAL 320b). Since the namespace operation is persistently stored in the secondary WAL 320b, the secondary site can recover in the event of a crash or failure by replaying the namespace operation record. Note that namespace operations are generally idempotent, i.e., unchanged in file system namespace despite multiple performances (executions).

In an embodiment, the primary file system 270a receives the persistent storage acknowledgement 410 that the namespace operation has been persistently logged on the secondary WAL 320b and begins performing (executing) metadata updates or inode changes relating to the namespace operation. Note that execution of the namespace operation may result in execution of multiple operations at once, i.e., atomically as a single transaction so that namespace consistency is maintained. That is, a transaction is defined as a set of operations that is treated as a single transaction performed atomically—all or nothing. Execution of the namespace operations are directed to the persistent, distributed metadata store 350 accessed via an interface that keeps track of the locations of the metadata. That is, the namespace operation updates (metadata) are persisted in a distributed metadata store 350a,b at the backend persistent storage 340 of the primary and secondary sites. During the namespace operation execution, each namespace (e.g., of storage container 230) is updated with the changes related to that namespace by, e.g., updating the distributed metadata store 350. All changes (e.g., namespace operations, general inode changes) are synchronously executed and pushed (drained) to the backend persistent metadata store 350 (e.g., immediately in-line). Typically, the updates/changes occur with every namespace operation to maintain consistency, especially since many data changes (e.g., data write operations to a file) may require prior namespace operations (e.g., file creation) to have been already performed.

In an embodiment, metadata updates for namespace operations directed to storage container 230a on the primary site A that are synchronously protected may be batched and updated together asynchronously (instead of immediately in-line or synchronously) when flushed (pushed) to the persistent backend distributed metadata store 350a. For example, a request containing a namespace operation 325 (e.g., a rename operation) issued by a client (UVM 210a) at the primary site A is logged as a record on the primary WAL 320a and the namespace operation record is replicated to the secondary WAL 320b at the secondary site B. The secondary site sends a persistent storage acknowledgement 410 to the primary site A indicating persistent storage of the namespace operation. In an embodiment of synchronous mode, the primary site A immediately executes the namespace operation changes to metadata (e.g., an inode) and updates (commits) the metadata change on the persistent backend metadata store 350a “in-line” as the operations are received (e.g., synchronous mode) before sending the completion acknowledgement 410 indicating operation completion to the client (UVM 210a). This delays acknowledgement to the client and thus increases I/O latency.

Instead, in an embodiment of asynchronous mode, updates to the persistent metadata store 350a at the primary site A are not performed immediately in-line but rather may be delayed, i.e., processed asynchronously (e.g., batched) but still in order from the metadata store allowing for better utilization of the file system. The delay may be reliably implemented because an intent to update (i.e., the logged namespace operation request) is persisted in the primary WAL 320a. That is, the primary site A performs the updates asynchronously, e.g., not in-line (synchronously) with the replication but according to utilization of the file system. Once the secondary site B acknowledges persistent recording of the namespace operation/transaction update in the secondary WAL 320b, the primary site A (primary file system 270a) may acknowledge completion of the operation to the client even though it has not actually committed the operation update change to the persistent metadata store 350a on the primary site. Notably, execution of the operations is still performed in order, however a degree of drift in namespace consistency between the sites may occur as processing of transactions in the respective WALs 320a,b between the primary and secondary sites may occur at different rates. Accordingly, the delayed execution of operation is termed an “asynchronous transaction.”

However, during processing and updating of namespace transaction operations occurring asynchronously on the primary site A, the secondary site B may encounter a slow-down or lag (delay) in executing (processing) the namespace metadata updates and committing the updates to the persistent distributed metadata store 350b occurring synchronously on the secondary site. The lag (delay) of the secondary site processing is dependent on how fast the primary site A sends the transaction operations, i.e., the faster the asynchronous transaction operations are processed on the primary site A and sent to the secondary site B, the greater the delay that may be realized in synchronous transaction operation processing on the secondary site B. In an embodiment, the asynchronous transaction updates are only available on the primary site, whereas secondary site namespace changes (updates) to the distributed metadata store 350b are instead strictly in-line or synchronous. As a result, the secondary site B may be slower in processing the namespace operations as compared to the primary site A and the speed at which the sites process the operations may be quite different, particularly when a burst of namespace operation requests is issued by the client (UVM 210a), especially since secondary sites are usually configured with less capability than a primary sites due to cost.

Accordingly, namespace processing on the secondary site may gradually lag (behind) the primary site processing to a point at which a maximum number (predetermined threshold) of records that the secondary WAL 320b can maintain (e.g., to ensure a reasonable recovery time) may be reached (backlogged), which may impact recovery of logged records beyond that threshold. This situation may arise if the secondary site B is not configured properly, e.g., with respect to processing capacity (e.g., CPUs) or storage capacity (e.g., backend store) in relation to (or as compared with) the primary site A. Thus, secondary site processing may be hindered (slower) versus that of the primary site. Moreover, since the transactions are batched updated (asynchronously) on the primary site, processing at the primary site is usually much faster than the secondary site due to more efficient file system utilization despite any less capable configuration of the secondary site, which is not configured for batch updating of the transactions.

The embodiments described herein are directed to a technique configured to alleviate backlog of file system operations recorded in a WAL in a multi-site DR environment. To address the backlog (non-uniformity of namespace transaction processing between the sites), the technique provides primary and secondary site communication messaging such that, for every replicated WAL record (i.e., namespace operation client request) to the secondary site B, the secondary site B replies to the primary site A with feedback indicating a number (count) of pending namespace operation records remaining in the secondary WAL 320b for secondary storage container 230b. Thus, the count of pending namespace operation records is an indication of the pending namespace operations that have not yet been processed for secondary storage container 320b and represents an amount of work (namespace operation processing) to be performed to update metadata to the distributed metadata store 350b. Note that, in an embodiment, each WAL record has a storage container identifier (ID) field that stores an ID of the storage container associated with the transaction record.

In an embodiment, the secondary WAL 320b may be used with other storage containers, i.e., storage containers that are not utilized for synchronous replication with the primary site, such as storage containers that are “local” to the secondary site (including other VMs) and also configured to store processed namespace operations. Processing of operations for such local storage containers further impacts the processing speed (behavior) of transactions pending in the secondary WAL 320b. That is, the WAL record (e.g., namespace operation) processing on both sites is dynamically dependent on the secondary WAL record processing behavior. The technique described herein provides the feedback feature to enable dynamic processing adjustment at the sites so that the primary site does not overwhelm the secondary site to such an extent that the secondary site cannot meet recovery objectives (i.e., recovery time) in the event of a crash.

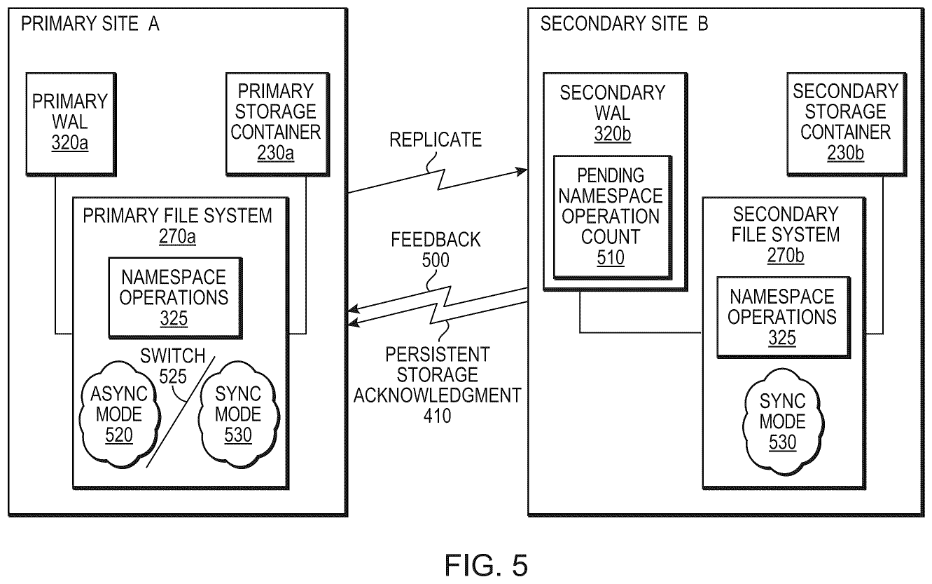

FIG. 5 is a diagram illustrating exemplary feedback used in replication of file systems in the multi-site data DR environment. In an embodiment, processing of the namespace operations 325 by the primary file system 270a at the primary site A may be adaptively configured to dynamically transition (switch 525) from asynchronous (async) mode 520 to synchronous (sync) mode 530 based on feedback 500 received from the secondary file system 270b on the secondary site B. According to the technique, the feedback 500 may be embodied as flow control information indicative of a rate at which the secondary file system 270b processes the namespace operations 325, wherein the processing rate is computed based on a queue size or count of namespace operations pending (i.e., backlogged) in the secondary WAL 320b. Illustratively, the feedback may reflect a pending namespace operation count 510 in the secondary WAL 320b that indicates the count (number) of pending namespace operations that have yet to be processed by the secondary file system 270b per secondary storage container 230b.

When the secondary site processing is as fast as (or faster than) primary site processing of the namespace operations, the WALs are expected to be nearly empty so that failover recovery time is assured with little to no drift in namespace consistency between the sites. However, if primary site processing is faster than the secondary site processing, the secondary site processing starts lagging behind that of the primary site and the count 510 of pending namespace operation records logged in the secondary WAL 320b (and not persisted in the backend distributed metadata store 350b) increases. If a failover of the UVM 210a at primary site A occurs, recovery time increases since the pending namespace operations (transactions) in the secondary WAL 320b must be performed (replayed) to establish a consistent state before the failover may be addressed. Notably, replay of the secondary WAL 320b may consume an extended period of time that exceeds recovery time objectives if the lag is substantial. The feedback feature is provided to obviate such a situation by enabling constant monitoring (checking) of the secondary WAL capacity and adjusting processing and replication of operations from the primary site to allow the secondary site to reduce the lag as measured by a threshold number of outstanding transactions.

In an embodiment, there is no separate communication channel for the feedback 500. Illustratively, the feedback 500 (indicative of the pending namespace operation count 510) may be “piggy-backed” onto (e.g., included within) the persistent storage acknowledgement 410 returned by the secondary site B to the primary site A. As noted, namespace operation requests issued by the client (UVM 210a) at the primary site A are logged as records at the primary WAL 320a and replicated as WAL records to the secondary site B. The feedback 500 from the secondary site provides an indication of the capacity of the secondary WAL 320b at a point-in-time. The primary site (e.g., primary file system 270a) examines the feedback 500 to determine whether to (i) continue with asynchronous (batch) processing of records to the persistent distributed metadata store 350a for the primary storage container 230a or (ii) discontinue asynchronous processing and switch to synchronous processing for the container so that the secondary site B can eventually catch up. Essentially, the primary site A transitions (switches) between asynchronous (async) and synchronous (sync) transaction processing based on the feedback 500 received from the secondary site B.

In an embodiment, the feedback 500 is threshold-driven with respect to the count 510 of namespace operation (transaction) records pending in the secondary WAL 320b; alternatively, the feedback may be a percentage of fullness of the secondary WAL. Once the primary site is informed that the secondary site is approaching the predetermined threshold (e.g., 75%-90% of the threshold), the primary site (e.g., primary file system 270a) transitions/switches 525 from async mode 520 to sync mode 530 to slow down. The predetermined threshold ensures that recovery can be realized (achieved) within a recovery objective, i.e., certain time limit. Notably, the threshold is not as simple as an absolute count (or 75%-95%) of namespace operation (transaction) records pending in the secondary WAL 320b. Computation of the threshold also considers whether the pending records are included in a same directory/files portion (e.g., dataset) of the file system directory structure for the storage container or are dispersed among different, disparate datasets. That is, the threshold computation also considers whether processing of the records may be performed serially (within the same dataset) or in parallel or concurrently (among different datasets).

In an embodiment, a reasonable recovery time limit (e.g., 30 secs) for the secondary WAL 320b to recover is established, i.e., the predetermined threshold falls within that time limit to ensure that recovery objectives are met. The predetermined threshold is illustratively a “soft” (flexible) threshold determined based on heuristics according to concurrent processing possibility of pending WAL records. When the threshold is realized, the primary file system 270a switches from, e.g., async mode 520 to sync mode 530. Meanwhile, the feedback 500 continues to be received at the primary site A from the secondary site B so that the primary site knows when to revert (re-switch) back to async mode 520. The soft threshold is constantly monitored (not constantly updated or reevaluated but may be configurable) but only initially computed based on characteristics (heuristics) of serial/parallel processing of records (as discussed above).

Note that, in an embodiment, the predetermined threshold may be a “hard” (fixed) threshold if the secondary file system 270b is not able to process transactions and catchup even after primary file system 270a has slowed down to sync mode 530. Upon reaching the hard threshold, the namespace operations are completely blocked and failed, and replication of the operations from the primary file system 270a are stopped (suspended). At this time no communication occurs between the file systems. Eventually, after a certain timeout period, replication of the namespace operations is unblocked to allow processing of the operations at primary file system 270a and reception of the latest feedback from secondary file system 270b.

In an embodiment, the predetermined threshold is used to switch 525 from async mode 520 to sync mode 530 (and thereafter back to async mode 520) based on whether the work count 510 pending in the secondary WAL 320b goes above the threshold (switch to sync mode 530 until the secondary site catches up) or falls below the threshold (switch back to async mode 520). In addition, the soft and hard thresholds may operate together with the feedback as follows:
i) when the feedback is greater than or equal to the hard threshold, then operations from the primary file system are suspended (blocked) as described above;
ii) when the soft threshold is less than or equal to the feedback, and the feedback is also less than the hard threshold, then sync mode 530 is used by the primary file system;
iii) when the feedback is less than the soft threshold, then async mode 520 is used by the primary file system.

The feedback control messaging is used to rebalance the processing of replicated operations so that (i) processing at the secondary site does not backup (i.e., a capacity of the secondary site to process such namespace operations is not overwhelmed), (ii) a capacity of the WAL is not overwhelmed and (iii) drift in namespace consistency is limited between the primary and secondary sites which impacts disaster recovery time. For example, when the pending work count goes above (exceeds) the threshold, the primary file system 270a switches from async mode 520 to sync mode 530 to slow down namespace transaction processing at the primary site A and allow the secondary site B to catch up with its namespace transaction processing. The primary site A then switches back to async mode 520 when the pending work count 510 falls below the predetermined threshold.

In an embodiment, namespace operation requests continue to be issued by the client (UVM 210a) during the processing mode transitions that occur at the primary site A. The namespace operations of the requests are logged as records to the primary WAL 230a and replicated to the secondary WAL 320b. With every namespace operation record that is replicated, the secondary site B sends feedback 500 to the primary site A regarding how much (amount of) work (e.g., WAL records) is pending in the secondary WAL 320b. The feedback 500 thus occurs at a per namespace transaction record granularity, i.e., in response to a WAL record replication, feedback 500 of “a number of current pending WAL records” is sent from the secondary site to primary site such that there is constant feedback 500 about the pending WAL record “queue” size at the secondary site. Note that alternative feedback may be embodied as a percentage of fullness of the WAL rather than a specific number of pending operations. Although the switching to sync mode 530 at the primary site may slow down operation completion acknowledgements (and increase acknowledgement latency) to the client, the latency on average is no worse than what is typical for system operation as an expected amount of time spent in the slower sync mode is of short duration and the primary site is predominantly in async mode most of the time. Notably, when switching back to async mode 520, a faster “client acknowledgement” experience (i.e., lower acknowledgement latency) may be realized.

While there has been shown and described illustrative embodiments directed to alleviating backlog of file system operations recorded in a file system WAL of a multi-site DR environment, it is to be understood that various other adaptations and modifications may be made within the scope of the embodiments herein. For example, embodiments have been shown and described herein with relation to namespace operation requests issued by a client during synchronous replication of file systems. However, the embodiments in their broader sense are not so limited and may, in fact, also allow for a burst of namespace operation requests issued by the client, such as in response to hypervisor-based snapshot generation workflows that may result in temporary file creations, deletions, and renames, e.g., essentially a burst of namespace operation activity. The threshold-based mode switching technique described herein may improve performance of the system when encountering such intense snapshot generation workflow activity substantially, e.g., by approximately 30% improvement.

The foregoing description has been directed to specific embodiments. It will be apparent however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks and/or electronic memory) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A non-transitory computer readable medium including program instructions for execution on one or more processors, the program instructions configured to:
receive a namespace operation directed to a container of a first file system at a first site;
record the namespace operation as a record in a first log at the first site;
in response to recording the namespace operation, acknowledge the namespace operation to a client;
replicate the namespace operation to a second site;
asynchronously process records of the first log at the first site to apply the namespace operation to the first file system; and
in response to receiving feedback at the first site from the second site that a second log at the second site storing the replicated namespace operation is exceeding a threshold of fullness, switch the asynchronous processing of records of the first log to synchronous processing such that subsequent received namespace operations at the first site are replicated to the second site as those operations are processed at the first site.

2. The non-transitory computer readable medium of claim 1, wherein the feedback from the second site includes a number of outstanding records remaining in the second log.

3. The non-transitory computer readable medium of claim 1, wherein the threshold of fullness for the second log is determined according to a recovery time objective in the event of a crash of a second file system.

4. The non-transitory computer readable medium of claim 1, wherein each record in the first log includes a storage container identifier (ID) field that stores an ID of the container associated with the record.

5. The non-transitory computer readable medium of claim 1, wherein the program instructions are further configured to:
in response to receiving feedback at the first site from the second site that the second log no longer exceeds the threshold of fullness, switch to asynchronous processing of records of first log.

6. The non-transitory computer readable medium of claim 1, wherein the threshold of fullness dynamically changes and is initially determined based on heuristics according to concurrent processing possibility of pending records in the first log.

7. The non-transitory computer readable medium of claim 1, wherein exceeding the threshold is determined when at least 75% of a predetermined threshold is exceeded.

8. The non-transitory computer readable medium of claim 1, wherein the feedback is piggy backed onto a persistent storage acknowledgement returned by the second site to the first site in response to replication of the namespace operation.

9. A method comprising:
receiving a namespace operation directed to a container of a first file system at a first site;
recording the namespace operation as a record in a first log at the first site;
in response to recording the namespace operation, acknowledging the namespace operation to a client;
replicating the namespace operation to a second site;
asynchronously processing records of the first log at the first site to apply the namespace operation to the first file system; and
in response to receiving feedback at the first site from the second site that a second log at the second site storing the replicated namespace operation is exceeding a threshold of fullness, switching the asynchronous processing of records of the first log to synchronous processing such that subsequent received namespace operations at the first site are replicated to the second site as those operations are processed at the first site.

10. The method of claim 9, wherein the feedback from the second site includes a number of outstanding records remaining in the second log.

11. The method of claim 9, wherein the threshold of fullness for the second log is determined according to a recovery time objective in the event of a crash of a second file system.

12. The method of claim 9, wherein each record in the first log includes a storage container identifier (ID) field that stores an ID of the container associated with the record.

13. The method of claim 9 further comprising:
in response to receiving feedback at the first site from the second site that the second log no longer exceeds the threshold of fullness, switching to asynchronous processing of records of first log.

14. The method of claim 9, wherein the threshold of fullness dynamically changes and is initially determined based on heuristics according to concurrent processing possibility of pending records in the first log.

15. The method of claim 9, wherein exceeding the threshold is determined when at least 75% of a predetermined threshold is exceeded.

16. The method of claim 9, wherein the feedback is piggy backed onto a persistent storage acknowledgement returned by the second site to the first site in response to replication of the namespace operation.

17. An apparatus comprising:
a network connecting one or more nodes of a first site and a second site, the node having a processor configured to execute program instructions to:
receive a namespace operation directed to a container of a first file system at a first site;
record the namespace operation as a record in a first log at the first site;
in response to recording the namespace operation, acknowledge the namespace operation to a client;
replicate the namespace operation to a second site;
asynchronously process records of the first log at the first site to apply the namespace operation to the first file system; and
in response to receiving feedback at the first site from the second site that a second log at the second site storing the replicated namespace operation is exceeding a threshold of fullness, switch the asynchronous processing of records of the first log to synchronous processing such that subsequent received namespace operations at the first site are replicated to the second site as those operations are processed at the first site.

18. The apparatus of claim 17, wherein the feedback from the second site includes a number of outstanding records remaining in the second log.

19. The apparatus of claim 17, wherein the threshold of fullness for the second log is determined according to a recovery time objective in the event of a crash of a second file system.

20. The apparatus of claim 17, wherein each record in the first log includes a storage container identifier (ID) field that stores an ID of the container associated with the record.

21. The apparatus of claim 17, wherein the processor is further configured to execute program instructions to:
In response to receiving feedback at the first site from the second site that the second log no longer exceeds the threshold of fullness, switch to asynchronous processing of records of first log.

22. The apparatus of claim 17, wherein the threshold of fullness dynamically changes and is initially determined based on heuristics according to concurrent processing possibility of pending records in the first log.

23. The apparatus of claim 17, wherein exceeding the threshold is determined when at least 75% of a predetermined threshold is exceeded.

24. The apparatus of claim 17, wherein the feedback is piggy backed onto a persistent storage acknowledgement returned by the second site to the first site in response to replication of the namespace operation.
